(19) United States
(12) Patent Application Publication
(10) Pub. No.: US 2002/0125440 A1
(43) Pub. Date: Sep. 12, 2002

(54) Method for fabrication of silicon octopole deflectors and electron column employing same

(75) Inventor: Max Gmur, Mosnang (CH)

Correspondence Address: PATENT COUNSEL, APPLIED MATERIALS, INC., Legal Affairs Department, P.O.BOX 450A, Santa Clara, CA, 95052, US

(73) Assignee: Applied Materials, Inc.

(21) Appl. No.: 09/800,797

(22) Filed: Mar. 7, 2001

(51) Int. Cl. H01J 3/14

(52) U.S. Cl. 250/396 R

(57) ABSTRACT

A wafer (300) has applied to it an etch stop layer (304) and a carrier wafer (308). Photoresist on the wafer (300) is patterned as multiple multipole deflectors by optical lithography. The pattern is then etched. The wafer (300) is removed from the carrier wafer (308) and the etch stop layer (304) is removed. The wafer (300) is then anodically bonded to a heat resistant glass substrate (309). Wafer dic ng is then employed to separate the chips and the octopole deflectors.

### BACKGROUND OF THE INVENTION

1. Field of the Invention

The present invention relates to electron deflectors and, in particular, to an improved silicon octopole deflector.

2. Description of the Related Art

Electron beam microcolumns based on microfabricated electron optical components and field emission sources operating under the scanning tunneling microscope (STM) aided alignment principle were first introduced in the late 1980s. Electron beam microcolumns are used to form a finely focused electron beam and offer the advantage of small physical size relative to standard columns.

A typical prior art microcolumn is a high-aspect-ratio micromechanical structure and includes microlenses, deflectors, and electrostatic multipoles for scanning and correction of astigmatism.

A microlens includes a plurality of aligned microlens components or elements. A typical microlens comprises, for example, multilayers of silicon chips (with membrane windows for the lens electrodes) or silicon membranes spaced apart by 100-500 μm thick insulating layers. Such a lens has a bore diameter that may vary from a few to several hundred μm. For optimum performance, the roundness and edge acuity of the bores are required to be in the nanometer range, and alignment accuracy between components is required to be on the order of less than 1 μm.

Fabrication of arrays of large numbers of multipoles is expected to be problematic. What is needed, therefore, is a method with a relatively high throughput and relatively high yield.

### SUMMARY OF THE INVENTION

In accordance with an embodiment of the present invention, arrays of multipoles are fabricated by applying a pattern to a wafer, said wafer mounted on a carrier wafer, an etch stop layer mounted therebetween, said pattern useful for producing one or more microdevices; etching through said pattern to said etch stop layer; removing said wafer from said carrier wafer and stripping said etch stop layer; and fixing a support layer to said wafer.

A microcolumn according to an implementation of the invention includes an electron beam source, one or more lenses for focusing the electron beam; and one or more microdevices, the microdevices formed by applying a pattern to a wafer mounted on a carrier wafer, an etch stop layer mounted therebetween. The pattern comprises one or more of the microdevices formed by etching the pattern; removing the wafer from said carrier wafer and stripping said etch stop layer; and bonding a pyrex layer to said wafer.

### BRIEF DESCRIPTION OF THE DRAWINGS

A better understanding of the invention is obtained when the following detailed description is considered in conjunction with the following drawings in which:

FIG. 1A is a block diagram of an electron column employing a multipole deflector according to an implementation of the present invention;

FIG. 1B illustrate the source lens and Einzel lens of FIG. 1A in exploded detail;

FIG. 2 is a diagram of an exemplary multipole deflector according to an implementation of the invention; and

FIG. 3A-3E illustrate fabrication of a multipole according to an implementation of the invention.

### DETAILED DESCRIPTION OF THE INVENTION

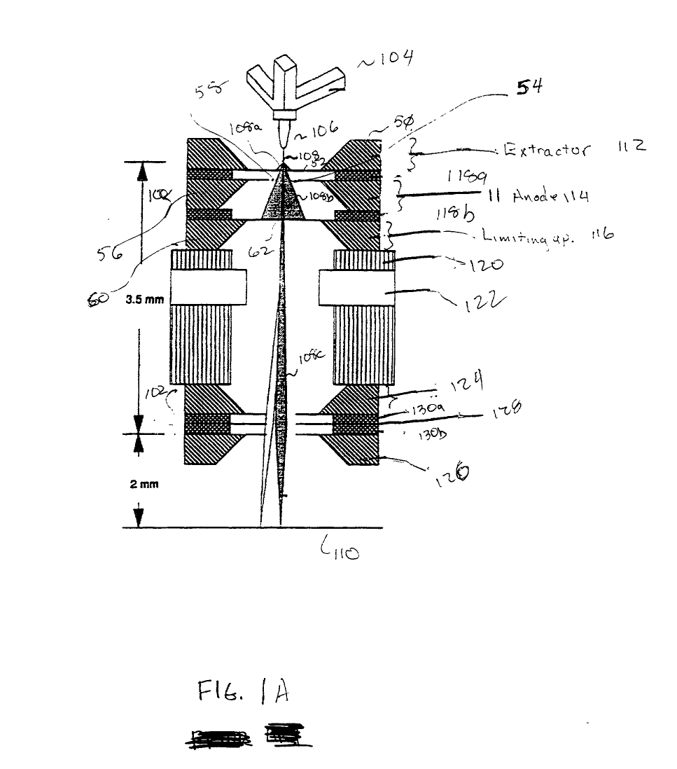

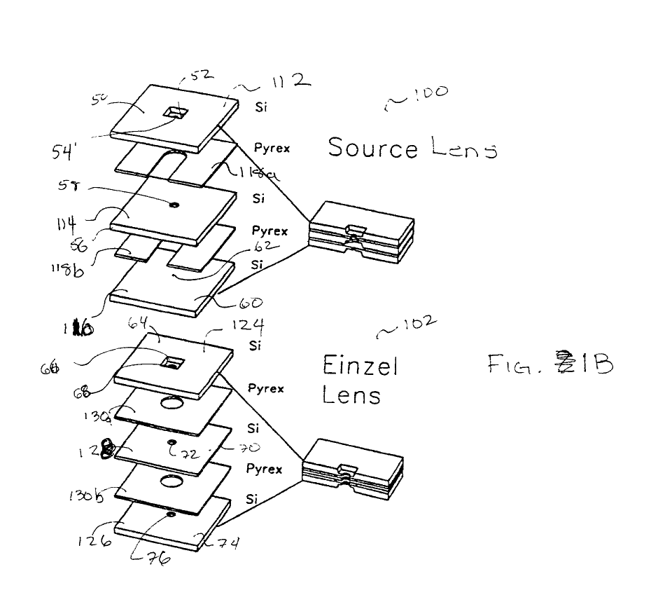

FIGS. 1-3 illustrate a method for fabricating octopole deflectors and an electron column employing such deflectors, according to an embodiment of the present invention.

Turning now to FIG. 1A, a cross-sectional schematic of a 1 kV microcolumn based on the well-known STM aligned field emission (SAFE) concept, showing a source lens section 100 and an Einzel lens section 102, is illustrated. The components of the source lens and the Einzel lens 102 are illustrated in exploded format in FIG. 1B.

The microcolumn (FIG. 1A) includes a three axis scanning tunneling microscope (STM) scanner 104 having a cathode tip 106. The source lens 100 includes an extractor 112 implemented as a frame portion 50 and an aperture portion 52, in which a 5 μm diameter extractor aperture 54 is situated. The source lens 100 (FIG. 1B) also includes an anode 114 implemented as a frame portion 56 in which a 100 μm diameter anode aperture 58 is situated. The frame 56 may include a thinner portion in which the actual aperture is located. In operation, electrons are emitted as a beam 108 from the tip 106 due to the potential difference between it and the extractor 112 and anode 114. The extractor 112 extracts and accelerates electrons to the desired energy. The electrons then accelerate past the anode 114 down the microcolumn.

The source lens 100 (FIG. 1B) further includes a limiting aperture 116 implemented as a frame portion 60 and a 2.5 μm diameter limiting aperture 62 situated therein. Again, the limiting aperture 116 may include a thinner portion in the frame 60 in which the actual aperture is situated. The limiting aperture 116 determines the beam convergence angle at the plane 110. The extractor 112 and limiting aperture 116 counteract beam spreading, as shown by the cone-shaped regions 108a, 108b. The extractor 112, anode 114, and limiting aperture 116 are separated by two insulating spacers 118a, 118b. The insulating spacers 118a, 118b are typically formed of a heat-resistant borosilicate glass, commonly known as Pyrex, but could be made of any other suitable insulator, such as SD-2 glass made by Hoya.

The source lens 100 is mounted on aluminum mounting base 120 (FIG. 1A), which contains an octopole scanner/stigmator 122, fabricated according to the present invention, for beam deflection across the sample at the plane 110.

The electron beam 108 then passes through the Einzel lens 102, which includes two 100-200 μm diameter silicon apertures 124 and 126 with a 1-1.5 μm thick free-standing silicon membrane aperture 128 disposed therebetween. The silicon aperture 124 (FIG. 1B) includes a frame portion 64, and a thinner aperture portion 66 in which the actual aperture 68 is situated. The membrane aperture 128 includes a membrane frame 70 and the actual aperture 72. Similarly, the silicon aperture 126 includes a frame portion 74 and the actual aperture 76. Finally, each silicon aperture 124, 126 is again separated by insulating spacers 130a, 130b. It is noted that a microcolumn having a configuration different from that particularly illustrated may make use of the multipole deflector of the present invention. Thus, the figures are exemplary only.

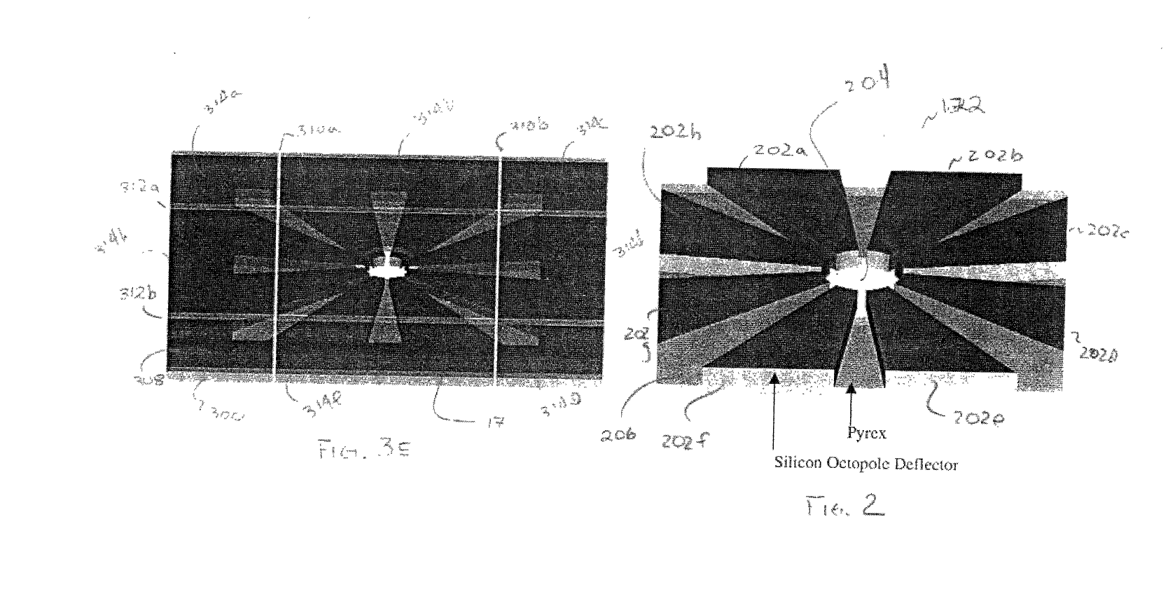

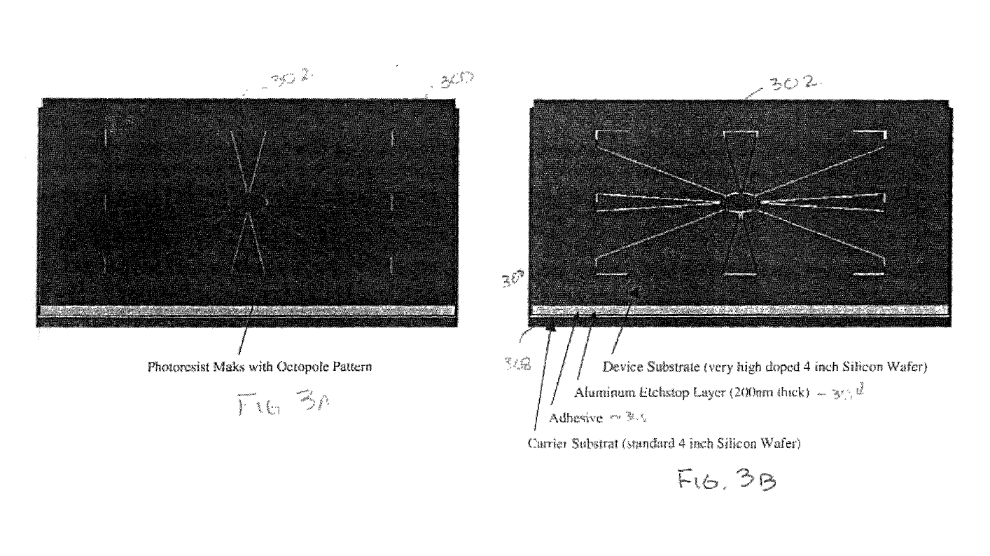

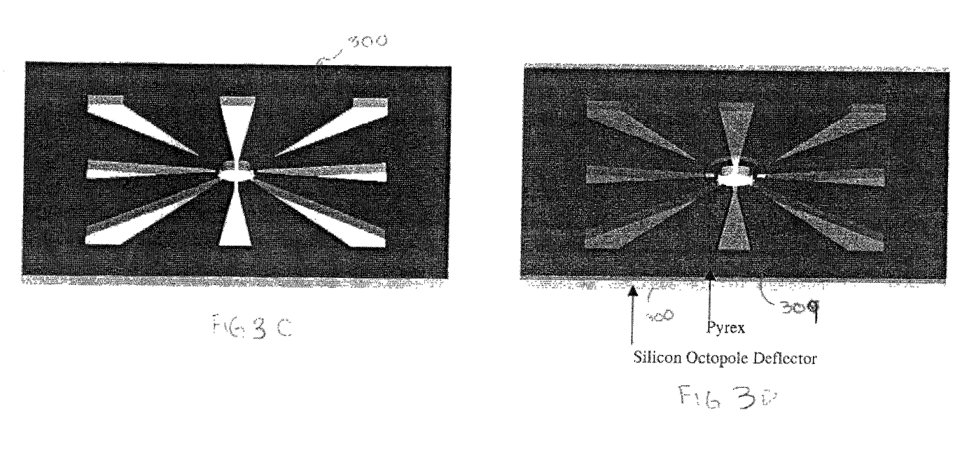

An exemplary multipole deflector 122 is shown in FIG. 2. As shown, the multipole is an octopole, i.e., has eight (8) silicon poles 202a-202h arrayed about a center hole 204. The silicon poles 202a-202h are mounted on a support layer 206, such as a heat resistant borosilicate glass, such as Pyrex. The diameter of the hole 204 is about 0.5-2 mm. The entire octopole 122 may be about 10 mm square. The entire octopole 122 is about 250-600 micrometers thick. The octopole 122 is formed on a doped wafer with a plurality of other octopoles, as will be explained in greater detail below. Manufacture of the octopole deflectors 122 according to the present invention is shown more particularly with reference to FIGS. 3A-3E. As shown in FIG. 3A, a wafer 300 is provided. The wafer 300 may be a highly-doped 4 inch silicon wafer, for example.

Initially, the wafer 300 is cleaned of various surface contaminants. The well-known technique referred to as the RCA method may be employed for cleaning. Next, an etch stop layer 304 is applied. The etch stop layer 304 may be an aluminum layer applied, for example, using physical vapor deposition (PVD). The aluminum etch stop layer is about 200 nm thick. Other suitable materials and deposition techniques may be employed, however. Next, the wafer 300 is applied to a carrier wafer 308. The wafer 300 may be applied to the carrier wafer 308 using a standard adhesives 306 (FIG. 3B).

The photoresist on the wafer 300 is patterned into the multipole patterns 302, for example, by techniques of optical lithography. As will be explained in greater detail below, the pattern 302 is actually a pattern of the material to be removed.

As shown in FIG. 3B, the photoresist pattern 302 is then etched into the wafer 300 using deep trench etching techniques, such as reactive ion etching (RIE). According to one such RIE process, silicon is etched alternately with the deposition of a polymer layer. For example, a short silicon etch/polymer deposition cycle (i.e., a few seconds) may be employed to achieve narrow trenches with aspect ratios (trench width/trench depth) of 50 or greater, and sidewall roughness below, for example, 100 nanometers. Other methods, such as electron-cyclotron-resonance (ECR) etching, active silicon ion etching, inductively-coupled-plasma (ICP) etching, may be used. The etching may be done through the wafer 300 and may be stopped at the etch stop layer 304.

Next, as shown in FIG. 3C, the carrier wafer 304 is removed from the wafer 300 and the etch stop layer 304 is removed. A phospohoric acid based aluminum etchant, such as those available from Transene, Inc., Dancers, Mass, may be employed to remove the etch stop layer 314. The wafer 300 is again cleaned, for example, using the RCA method.

Next, as shown in the FIG. 3D, the wafer 300 is bonded to a support layer 309, such as heat-resistant borosilicate glass, such as Pyrex. A conventional approach is to use anodic bonding. Anodic bonding is an electrochemical process for heat sealing of glass to metal and semiconductors. At elevated temperatures (300-600 C), Na₂O in the Pyrex or other glass disassociates to form sodium and oxygen atoms. By applying a potential between a first silicon layer and a glass insulation layer, sodium ions in the glass migrate from the silicon-glass interface, while uncompensated oxygen anions move toward the induced positive charge of the silicon anode to form chemical bonds. It is noted that, while Pyrex typically may be used, anodic bonding may be performed with a support layer comprising any glass including sufficient amounts of sodium.

Wafer dicing is used to separate the batch-processed octopole devices and simultaneously separate the octopole deflector electrodes. As shown in FIG. 3E, the wafer 300 and the bonded support layer 308 are diced at kerfs 310a, 310b, and 312a, 312b. Known dicing techniques and systems may be used. For example, once the Pyrex 308 has been bonded to the wafer 300, the combined assembly is fixed onto a dicing stage and the assembly is diced using a conventional circular diamond-impregnated dicing saw. The sections 314a-314h are removed, and what remains are the octopole devices 122, as shown in FIG. 2.

The invention described in the above detailed description is not intended to be limited to the specific form set forth herein, but is intended to cover such alternatives, modifications and equivalents as can reasonably be included within the spirit and scope of the appended claims.

What is claimed is:

1. A method, comprising:
applying a pattern to a wafer, said wafer mounted on a carrier wafer, an etch stop layer mounted therebetween, said pattern useful for producing one or more microdevices;
etching said pattern;
removing said wafer from said carrier wafer and stripping said etch stop layer; and
fixing a support layer to said wafer.

2. A method according to claim 1, further comprising dicing said wafer to separate said microdevices from said wafer.

3. A method according to claim 2, wherein said etching comprises trench etching, wherein only outlines of said pattern are etched.

4. A method according to claim 3, including separating microdevice components.

5. A method according to claim 4, said microdevices comprising multipole deflectors.

6. A microdevice, said microdevice formed by
applying a pattern to a wafer, said wafer mounted on a carrier wafer, an etch stop layer mounted therebetween, said pattern said pattern useful for producing one or more microdevices;
etching said pattern;
removing said wafer from said carrier wafer and stripping said etch stop layer; and
bonding a support layer to said wafer.

7. A microdevice according to claim 6, further formed by dicing said wafer to separate said microdevices from said wafer.

8. A microdevice according to claim 7, wherein said etching comprises trench etching, wherein only outlines of said pattern are etched.

9. A microdevice according to claim 8, including separating microdevice components.

10. A microdevice according to claim 9, said microdevice comprising a multipole deflector.

11. An electron column, comprising:
an electron beam source;
one or more lenses for focusing said electron beam; and
one or more microdevices, said microdevices formed by
applying a pattern to a wafer, said wafer mounted on a carrier wafer, an etch stop layer mounted therebetween, said pattern useful for producing one or more microdevices;
etching said pattern;
removing said wafer from said carrier wafer and stripping said etch stop layer; and
bonding a support layer to said wafer.

12. An electron column according to claim 11, said microdevices further formed by dicing said wafer to separate said microdevices from said wafer.

13. An electron column according to claim 12, wherein said etching comprises trench etching, wherein only outlines of said pattern are etched.

14. An electron column according to claim 13, including separating microdevice components.

15. An electron column according to claim 14, said microdevice comprising a multipole deflector.

16. A method for constructing an electron column, comprising:
providing an electron beam source;
providing one or more lenses for focusing said electron beam; and
providing one or more microdevices, said microdevices formed by
applying a pattern to a wafer, said wafer mounted on a carrier wafer, an etch stop layer mounted therebetween, said pattern useful for producing one or more microdevices;
etching said pattern;
removing said wafer from said carrier wafer and stripping said etch stop layer; and
bonding a support layer to said wafer.

17. A method according to claim 16, said microdevices further formed by dicing said wafer to separate said microdevices from said wafer.

18. A method according to claim 17, wherein said etching comprises trench etching, wherein only outlines of said pattern are etched.

19. A method according to claim 18, including separating microdevice components.

20. An method according to claim 19, said microdevice comprising a multipole deflector.
